(19) United States
(12) Patent Application Publication
(10) Pub. No.: US 2026/0080616 A1
(43) Pub. Date: Mar. 19, 2026

(54) DEVICE AND METHOD FOR MANAGING VIRTUAL-ENVIRONMENT CONTENT

(71) Applicants: Hyundai Motor Company, Seoul (KR); Kia Corporation, Seoul (KR); KOOKMIN UNIVERSITY INDUSTRY-ACADEMIC COOPERATION FOUNDATION, Seoul (KR)

(72) Inventors: Ki Chang KIM, Hwaseong-Si (KR); Eun Soo JO, Hwaseong-si (KR); Dong Chul PARK, Hwaseong-si (KR); Se Joon LIM, Seoul (KR)

(73) Assignees: Hyundai Motor Company, Seoul (KR); Kia Corporation, Seoul (KR); KOOKMIN UNIVERSITY INDUSTRY-ACADEMIC COOPERATION FOUNDATION, Seoul (KR)

(21) Appl. No.: 19/059,051

(22) Filed: Feb. 20, 2025

(30) Foreign Application Priority Data
Sep. 19, 2024 (KR) 10-2024-0126488

(51) Int. Cl. G06T 17/00; G02B 27/01; G06F 3/16; G06T 7/90; G06V 10/56; G06V 10/60

(52) U.S. Cl. CPC G06T 17/00; G02B 27/017; G06F 3/165; G06T 7/90; G06V 10/56; G06V 10/60

(57) ABSTRACT

In a device for managing virtual-environment content, the device including at least one processor and a memory operatively connected to the at least one processor and configured to store at least one program executed by the at least one processor, the processor includes a first processing unit configured to extract image information of virtual-environment content output through a head-mounted display (HMD), a second processing unit configured to analyze image parameters forming the image information and determine first scores which are quantitative indices of the image parameters, a third processing unit configured to set voice parameters corresponding to the image parameters and determine second scores which are quantitative indices of the corresponding voice parameters using the first scores, and a fourth processing unit configured to output voice information of the virtual-environment content by replacing the voice parameters with the second scores.

### CROSS-REFERENCE TO RELATED APPLICATION

The present application claims priority to Korean Patent Application No. 10-2024-0126488, filed on Sep. 19, 2024, the entire contents of which is incorporated herein for all purposes by this reference.

### BACKGROUND OF THE PRESENT DISCLOSURE

### Field of the Present Disclosure

The present disclosure relates to a device and method for managing virtual-environment content.

### Description of Related Art

Motion sickness or cyber sickness is kinesia that occurs during the use of virtual reality (VR), augmented reality (AR), video games, three-dimensional (3D) movies, and the like. This is caused by a mismatch between movement-related visual information and actual physical sensations, and symptoms may be similar to traditional motion sickness.

Lately, there has been an increase in consumption patterns in the emotional information and communications technology (ICT) field for detecting and perceiving users'emotions and providing services using information technology (IT) devices. Also, with the technological development and an increase in the supply of autonomous vehicles, the market of content which may be experienced in vehicles is rapidly expanding.

For the present reason, various studies are being conducted on cyber sickness which is caused by a mismatch between the visual and auditory senses during the experience of virtual content.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a virtual-environment content management device and method for generating or adjusting voice information so that the voice information corresponds to an image of virtual-environment content.

The technical object of the present disclosure is also directed to providing a virtual-environment content management device and method for predicting and determining motion sickness caused by sensory conflict in a virtual environment.

According to various aspects of the present disclosure, there is provided a device for managing virtual-environment content, the device including at least one processor and a memory operatively connected to the at least one processor and configured to store at least one program executed by the at least one processor. The processor includes a first processing unit configured to extract image information of virtual-environment content output through a head-mounted display (HMD), a second processing unit configured to analyze image parameters forming the image information and determine first scores which are quantitative indices of the image parameters, a third processing unit configured to set voice parameters corresponding to the image parameters and determine second scores which are quantitative indices of the corresponding voice parameters using the first scores, and a fourth processing unit configured to output voice information of the virtual-environment content by replacing the voice parameters with the second scores.

The processor may further include a fifth processing unit configured to determine a correlation index of the virtual-environment content by comparing the first scores with the second scores in accordance with correspondence between the image parameters and the voice parameters.

The third processing unit may adjust the second scores in accordance with the correlation index.

The fifth processing unit may be configured to determine the correlation index using weights in accordance with individual characteristics.

The fifth processing unit may be configured to determine a possibility of motion sickness happening in accordance with the correlation index.

The second processing unit may be configured to determine the first scores by analyzing the image parameters including impact intensity, color, brightness, and contact time.

The third processing unit may set loudness, timbre, pitch, and duration as the voice parameters corresponding to the impact intensity, the color, the brightness, and the contact time, respectively.

The second processing unit may be configured to determine the first score of the impact intensity by quantitatively evaluating intensity of the image information, and the third processing unit may be configured to determine the second score of the loudness proportionate to the first score.

The second processing unit may be configured to determine the first score of the color by quantitatively evaluating a color feeling of the image information, and the third processing unit may be configured to determine the second score of the timbre proportionate to the first score.

The second processing unit may be configured to determine the first score of the brightness by quantitatively evaluating luminance of the image information, and the third processing unit may be configured to determine the second score of the pitch proportionate to the first score.

The second processing unit may be configured to determine the first score of the contact time by quantitatively evaluating the contact time, and the third processing unit may be configured to determine the second score of the duration proportionate to the first score.

According to various aspects of the present disclosure, there is provided a method of managing virtual-environment content which is performed by a computing device including at least one processor and a memory operatively connected to the at least one processor and configured to store at least one program executed by the at least one processor. The method includes extracting image information of virtual-environment content output through an HMD, analyzing image parameters forming the image information and determining first scores which are quantitative indices of the image parameters, setting voice parameters corresponding to the image parameters, determining second scores which are quantitative indices of the corresponding voice parameters using the first scores, and replacing the voice parameters with the second scores and outputting voice information of the virtual-environment content.

The method may further include comparing the first scores with the second scores in accordance with correspondence between the image parameters and the voice parameters and determining a correlation index of the virtual-environment content.

The method may further include adjusting the second scores in accordance with the correlation index.

The method may further include determining a possibility of motion sickness happening in accordance with the correlation index.

The determining of the first scores may include determining the first scores by analyzing the image parameters including impact intensity, color, brightness, and contact time, and the setting of the voice parameters may include setting loudness, timbre, pitch, and duration as the voice parameters corresponding to the impact intensity, the color, the brightness, and the contact time, respectively.

The determining of the second scores may include determining the first score of the impact intensity by quantitatively evaluating intensity of the image information, and determining the second score of the loudness proportionate to the first score.

The determining of the second scores may include determining the first score of the color by quantitatively evaluating a color feeling of the image information, and determining the second score of the timbre proportionate to the first score.

The determining of the second scores may include determining the first score of the brightness by quantitatively evaluating luminance of the image information, and determining the second score of the pitch proportionate to the first score.

The determining of the second scores may include determining the first score of the contact time by quantitatively evaluating the contact time, and determining the second score of the duration proportionate to the first score.

A device and method for managing virtual-environment content according to various exemplary embodiments allow voice information to be generated and adjusted to correspond to virtual-environment content.

In the present way, it is possible to minimize a mismatch between an image and voice of virtual-environment content experienced by a user.

In the present way, it is possible to predict and minimize motion sickness which is caused by sensory conflict in a virtual environment.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating an operating environment of a device for managing virtual-environment content according to an exemplary embodiment of the present disclosure.

FIG. 2 and FIG. 3 are diagrams illustrating the concept of virtual-environment content according to an exemplary embodiment of the present disclosure.

FIG. 4 is a block diagram of a device for managing virtual-environment content according to an exemplary embodiment of the present disclosure.

FIG. 5 is a diagram illustrating operations of the device for managing virtual-environment content according to an exemplary embodiment of the present disclosure.

FIG. 6 is a diagram illustrating operations of a processor according to an exemplary embodiment of the present disclosure.

FIG. 7 is a flowchart of a method of managing virtual-environment content according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical spirit of the present disclosure is not limited to some disclosed exemplary embodiments and may be implemented in a variety of different forms. Within the technical spirit of the present disclosure, one or more components of embodiments may be selectively combined or substituted and used.

Also, terms (including technical and scientific terms) may be interpreted with meanings that may be generally understood by those of ordinary skill in the art unless clearly and particularly defined and described. Generally used terms, such as terms defined in a dictionary, may be interpreted in consideration of the meaning in the context of the related technology.

Furthermore, terms used in embodiments of the present disclosure are for describing the exemplary embodiments and are not intended to limit the present disclosure.

In the present specification, a singular form may include the plural form unless specifically stated in the phrase, and when described as “at least one (or one or more) of A, B, and C,”it may include at least one of all combinations thereof.

Terms such as “first,” “second,” “A,” “B,” “(a),” “(b),” and the like may be used in describing components of embodiments of the present disclosure.

These terms are only for distinguishing a component from others, and the nature, turn, sequence, or the like of the component is not limited by the terms.

When a component is described as being “connected,” “coupled,” or “interconnected” to another component, the component may not only be directly connected, coupled, or interconnected to the other component, but may also be “connected,” “coupled,” or “interconnected” to the other component via yet another component therebetween.

Furthermore, when a component is described as being formed or disposed “on (above)” or “under (below)” another component, the two components may be in direct contact with each other or one or more other components may be formed or disposed therebetween. Furthermore, when a component is expressed as being “on (above)” or “under (below)” another component, the component may be not only in an upward direction but also in a downward direction based on the other component.

Hereinafter, various exemplary embodiments will be described in detail with reference to the accompanying drawings. Throughout the drawings, like components will be assigned like reference numerals, and the detailed description thereof will be omitted.

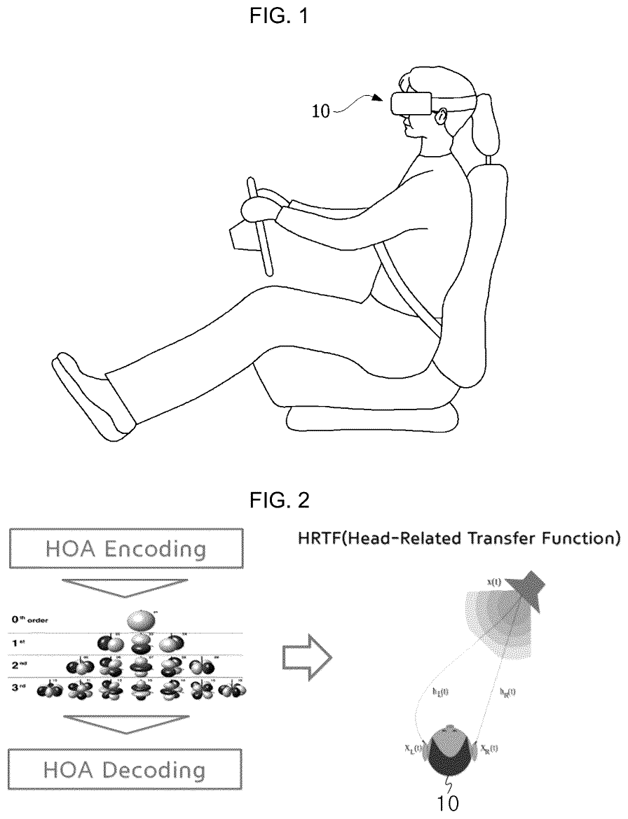

FIG. 1 is a diagram illustrating an operating environment of a device for managing virtual-environment content according to an exemplary embodiment of the present disclosure. Referring to FIG. 1, a device 100 for managing virtual-environment content according to various exemplary embodiments of the present disclosure may be applied to an autonomous vehicle user who experiences virtual-environment content while wearing a head-mounted display (HMD) in a metaverse environment or the like.

According to an exemplary embodiment of the present disclosure, the HMD 10 may be a display device which is disposed in the autonomous vehicle and worn on the user's head. The HMD 10 may be mainly used in virtual reality (VR) and augmented reality (AR) applications and disposed in front of the user's eyes to provide an immersive visual experience.

The HMD 10 may include a display panel that provides an image to the user using two small screens or one large screen, and a lens which is placed between the display and the user's eyes to adjust the image in accordance with the eyes.

The HMD 10 may track the user's head movement using head tracking technology implemented through a gyroscope, an accelerometer, a magnetic field sensor, and the like and adjust the view of a screen.

The HMD 10 may provide virtual-environment content to the user wearing the HMD 10. According to an exemplary embodiment of the present disclosure, the virtual-environment content may include a virtual image and virtual sound generated based on the driving environment of a vehicle driver.

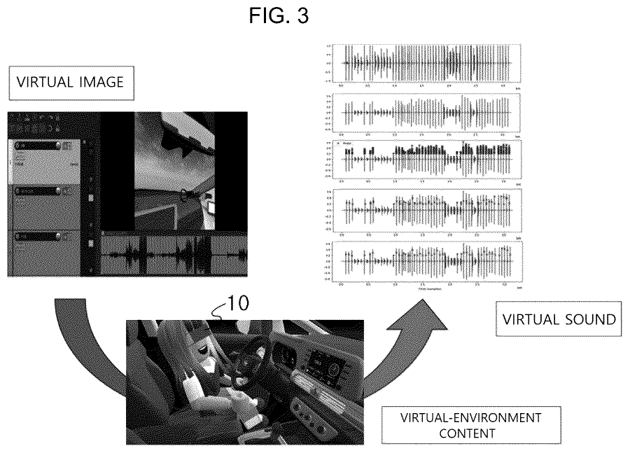

FIG. 2 and FIG. 3 are diagrams illustrating the concept of virtual-environment content according to an exemplary embodiment of the present disclosure. Referring to FIG. 2 and FIG. 3 together, a virtual image may be data for visualizing an external background that a vehicle driver or passenger may actually experience through a vehicle window while a vehicle travels.

Also, virtual sound may include various noises and music that the vehicle driver or passenger may recognize in the vehicle while the vehicle travels.

For example, the virtual sound may include a high-order ambisonics signal.

According to an exemplary embodiment of the present disclosure, virtual-environment content can reduce scattering of the fidelity of a virtual image and a virtual sound by applying sound perception differences resulting from the structures and shapes of heads and ears to head-related transfer function (HRTF) logic having the concept of a stereo sound implementation filter in consideration of user personalization. High-order ambisonics is a way of reproducing stereophonic sound by arranging speaker devices in a shape of a sphere centered on a listener. According to high-order ambisonics, it is possible to improve the heterogeneity caused by sound inaccuracy for an image and implement a lifelike sound.

The HRTF logic may transform sound waves which travel from a sound source located at a specific azimuth and elevation angle toward a listener into sound waves which have characteristics necessary for directional perception due to a head shape, an auricle structure, a shoulder shape, and the like of each individual that the sound waves pass through to reach the listener's ears. The HRTF logic may measure such characteristics that cause these changes and express the characteristics in the form of a transfer function. Since a body shape significantly varies for each individual, each person has a different HRTF. Accordingly, an HRTF customized for each user is required for accurately using the HRTF logic. However, to obtain HRTF data, it is necessary to take all measurements at a determined azimuth and altitude. Since equipment for taking measurements is complex and measuring takes a long time, it is impossible to measure HRTFs of all users in practice. Therefore, in general, signal processing for binaural sound source manufacturing may be performed using HRTF characteristics of a standard Knowles Electronics Manikin for Acoustic Research (KEMAR) dummy head or a public HRTF database (DB) of test subjects provided by a research institute such as Acoustics Research Institute (ARI), Center for Image Processing and Integrated Computing (CIPIC), Institut de Recherche et Coordination Acoustique/Musique (IRCAM), or the like.

High-order ambisonics is a technology for applying a panning technique for adjusting a sound position in a virtual space not only to a spherical surface but also to the inside or outside of the spherical surface. Spherical waves may be expressed as the sum of spherical harmonics. Using this, it is possible to play sound waves represented by spherical harmonics and add the sound waves to generate the same sound wave as is output by a virtual sound source desired by a user. Low-order ambisonics which utilizes a small number of spherical harmonics does not generate a large sound field but generates a very small sweet spot, a position where a user can feel an exact virtual sound field. To overcome this, high-order ambisonics technology is applied. The minimum number of speakers required for implementing n-order ambisonics technology may be defined as (n+1)2, where the n is natural number.

When the virtual-environment content is executed, the user perceives a virtual image and a virtual sound, and the device for managing virtual-environment content according to various exemplary embodiments of the present disclosure may analyze a correlation between image information and voice information through content analysis.

The device 100 for managing virtual-environment content may output voice information corresponding to image information to minimize the feeling of a mismatch of the user who experiences the virtual-environment content while sitting on a seat and wearing the HMD 10.

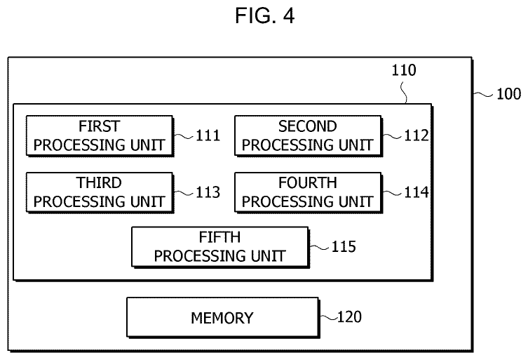

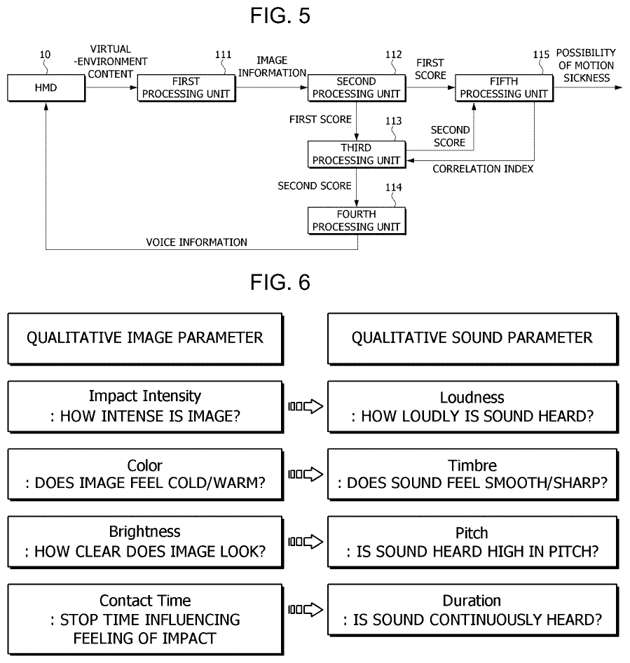

FIG. 4 is a block diagram of a device for managing virtual-environment content according to an exemplary embodiment of the present disclosure, and FIG. 5 is a diagram illustrating operations of the device for managing virtual-environment content according to an exemplary embodiment of the present disclosure. Referring to FIG. 4 and FIG. 5, the device 100 for managing virtual-environment content according to various exemplary embodiments of the present disclosure may include a processor 110 and a memory 120. The device 100 for managing virtual-environment content may be implemented in a vehicle to communicate with electronic portions in the vehicle.

According to an exemplary embodiment of the present disclosure, each component may include a function and capability other than those described above, and additional components other than those described below may be included. Also, according to an exemplary embodiment of the present disclosure, each component may be implemented using one or more devices that are physically separated, or a combination of one or more processors 110 or the one or more processors 110 and software. Unlike the example shown in the drawings, each component may not be clearly distinguished in terms of detailed operations.

The device 100 according to various exemplary embodiments of the present disclosure may be implemented in a logic circuit as hardware, firmware, software, or a combination thereof or implemented using a general-use computer or a special-purpose computer. The device may be implemented using a hardwired device, a field programmable gate array (FPGA), an application specific integrated circuit (ASIC), or the like. Also, the device may be implemented as a system on chip (SoC) including the one or more processors 110 and a controller.

Furthermore, the device 100 may be provided in a computing device or a server in which hardware elements are provided, in a form of software, hardware, or a combination thereof. The computing device or server may be various devices including all or some of a communication device, such as a communication modem or the like, for communicating with various devices or a wired or wireless communication network, a memory 120 for storing data for executing a program, a microprocessor for executing the program to perform a computation and give a command, and the like.

The memory 120 may include a DB. The memory 120 may be a non-transitory storage medium that stores instructions executed by the processor 110. The memory 120 may include at least one of storage media such as a random access memory (RAM), a static random access memory (SRAM), a read-only memory (ROM), a programmable read-only memory (PROM), an electrically erasable and programmable ROM (EEPROM), an erasable and programmable ROM (EPROM), a Hard Disk Drive (HDD), a solid state disk (SSD), an embedded multimedia card (eMMC), a universal flash storage (UFS), a web storage, and the like.

Herein, the memory 120 and the processor 100 may be implemented as separate semiconductor circuits. Alternatively, the memory and the processor may be implemented as a single integrated semiconductor circuit.

According to an exemplary embodiment of the present disclosure, a first processing unit 111, a second processing unit 112, a third processing unit 113, a fourth processing unit 114, and a fifth processing unit 115 may be implemented through the same process. For convenience of description, operations of each of the components will be separately described below.

In an exemplary embodiment of the present disclosure, the first processing unit 111, the second processing unit 112, the third processing unit 113, the fourth processing unit 114, and the fifth processing unit 115 may be implemented may be implemented as separate processors or as a single integrated processor.

The processor 110 may include at least one of processing devices such as an ASIC, a digital signal processor (DSP), a programmable logic device (PLD), an FPGA, a central processing unit (CPU), a microcontroller, a microprocessor 110, and the like.

The first processing unit 111 may extract image information of virtual-environment content output through an HMD.

The first processing unit 111 may extract image information from the virtual-environment content using a convolutional neural network (CNN) and extract temporal changes of the image information using a recurrent neural network (RNN).

The CNN of the first processing unit 111 may extract a feature map from the image information of the virtual-environment content through an n-dimensional conversion filter (n is a natural number of 2 or more) thereof.

For example, when performing training using data of one 90×90 (pixel) image, the first processing unit 111 may be configured to generate various types of 30×30 feature map images by applying a plurality of 3×3 convolutional filters. For example, in the case of n×n image data, when a 3×3 matrix is generated using a 3×3 filter (=convolution) and a largest value is extracted from the matrix as a representative value (=max pool), dimensions are reduced. When several filters are used and applied, it is possible to extract features of image data of a plant and generate a feature map. The first processing unit 111 may perform training using the generated feature map.

The RNN of the first processing unit 111 may be a deep learning algorithm which is used for learning a pattern from time-series data or sequence data. The RNN may be configured for processing sequence data in which a current state is affected by previous information.

At each time step of time-series data, a recurrent unit transmits information on a previous state to a current state so that the first processing unit 111 may perform consistent prediction and store and utilize previous input information to reflect the previous input information to a current output.

According to an exemplary embodiment of the present disclosure, the first processing unit 111 may be configured for processing the image information of the virtual-environment content as each frame image using the CNN and then train a temporal pattern between frames using the RNN.

The second processing unit 112 may be configured to determine first scores which are quantitative indices of image parameters by analyzing the image parameters forming the image information.

The second processing unit 112 may extract the image parameters including impact intensity, color, brightness, and contact time. The second processing unit 112 may be configured to determine a first score of each image parameter through quantitative evaluation of each of the extracted image parameters.

The impact intensity may be intensity of a specific event, a background, a movement, or the like in the image. For example, the impact intensity may be intensity of a falling or colliding object at the moment. The impact intensity may be mainly used to evaluate the severity of a specific event by analyzing the strength of a physical impact, a velocity change, acceleration, and the like.

The color may be various colors shown in the image. This may be expressed as red green blue (RGB) values and may play an important role in the atmosphere, subject matter, object identification, and the like of the image.

The brightness is a measure of the overall luminance of the image. This corresponds to the amount of light measured in the image and may generally be determined as the average of luminance values of pixels.

The contact time is an indicator for measuring a time that two objects are in contact in the image. For example, the contact time may be a time that a ball is in a player's hand in a sports game, a time that vehicles are in contact with each other in a crash, and the like.

The second processing unit 112 may be configured to determine a first score of the impact intensity by quantitatively evaluating intensity of the image information. The second processing unit 112 may be configured to determine the first score in accordance with the degree of impact intensity evaluated from the image information. For example, the second processing unit 112 may be configured to determine the first score as a larger value with an increase in the impact intensity.

The second processing unit 112 may be configured to determine a first score of the color by quantitatively evaluating a color feeling of the image information. The second processing unit 112 may be configured to determine the first score in accordance with the degree of the color feeling evaluated from the image information. For example, the second processing unit 112 may be configured to determine the first score as a larger value when the color feeling becomes colder.

The second processing unit 112 may be configured to determine a first score of the brightness by quantitatively evaluating luminance of the image information. The second processing unit 112 may be configured to determine the first score in accordance with the degree of luminance evaluated from the image information. For example, the second processing unit 112 may be configured to determine the first score as a larger value with an increase in the luminance value.

The second processing unit 112 may be configured to determine a first score of the contact time by quantifying the contact time. The second processing unit 112 may be configured to determine the first score in accordance with a period in which the contact time evaluated from the image information is maintained. For example, the second processing unit 112 may be configured to determine the first score as a larger value with an increase in the period in which the contact time is maintained.

The third processing unit 113 may set voice parameters corresponding to the image parameters and determine second scores that are quantitative indices of the corresponding voice parameters using the first scores.

The third processing unit 113 may set loudness, timbre, pitch, and duration as the voice parameters corresponding to the impact intensity, the color, the brightness, and the contact time, respectively. In other words, the third processing unit 113 may set a voice parameter corresponding to the impact intensity as loudness, set a voice parameter corresponding to the color as timbre, set a voice parameter corresponding to the brightness as pitch, and set a voice parameter corresponding to the contact time as duration.

The relationship between visual and vocal elements may cause synaesthesia in which the human brain feels two or more of the five senses (sight, sound, smell, taste, and touch) at the same time. Synaesthesia describes when a sensation caused by one stimulus simultaneously triggers a sensation in another domain. Mutual influence between different modalities of sensation is called synaesthesia, for example, in the case of hearing a sound due to an auditory stimulus and perceiving a color at the same time, the case of seeing a color due to a visual stimulus and perceiving a sound, and the like. Synaesthesia is applied to describe one kind of sensation within another kind of sensation in the relationship between color and sound, color and smell, sound and smell, and the like.

The third processing unit 113 may set voice parameters that are determined to be highly correlated with each other based on the relationship between the image and sound among these synaesthesia relationships as shown in FIG. 6.

Loudness is a measure of the magnitude or intensity of a voice signal. Loudness is determined by the amplitude of a sound and may express how loud or soft the sound is.

Timbre represents characteristics of a sound and distinguishes different musical instruments or voices even when the musical instruments or voices include the same pitch or loudness. This may be determined in accordance with the form of a frequency spectrum and the harmonic structure of a sound.

Pitch is the highness or lowness of a sound and may be determined in accordance with frequency. Pitch increases with an increase in frequency and decreases with a decrease in frequency.

Duration indicates a time length in which a voice signal maintains a certain level of loudness or more. This may be a time from the start of a sound to the end thereof.

The third processing unit 113 may be configured to determine a second score of loudness proportionate to the first score of the impact intensity. The third processing unit 113 may be configured to determine a higher loudness with an increase in the first score value of the impact intensity and determine a lower loudness with a decrease in the first score value of the impact intensity.

The third processing unit 113 may be configured to determine a second score of timbre proportionate to the first score of the color. The third processing unit 113 may be configured to determine a second score so that timbre is sharper with an increase in the first score value of the color and softer with a decrease in the first score value of the impact intensity.

The third processing unit 113 may be configured to determine a second score of pitch proportionate to the first score of the brightness. The third processing unit 113 may be configured to determine a higher pitch with an increase in the first score value of the brightness and determine a lower pitch with a decrease in the first score value of the brightness.

The third processing unit 113 may be configured to determine a second score of duration proportionate to the first score of the contact time. The third processing unit 113 may be configured to determine a longer duration with an increase in the first score value of the contact time and determine a shorter duration with a decrease in the first score value of the contact time.

The third processing unit 113 may adjust a second score in accordance with a correlation index. The third processing unit 113 may adjust a second score so that a correlation index value determined by the fifth processing unit 115 converges on a preset value. In other words, the third processing unit 113 can minimize the feeling of a mismatch between the image information and voice information experienced by the user by adjusting a second score so that a second score value of a voice parameter includes the same value as a first score of a corresponding image parameter. According to an exemplary embodiment of the present disclosure, the preset value may be the sum of weights as will be described below.

The fourth processing unit 114 may replace the voice parameters with the second scores and output voice information of the virtual-environment content.

Here, the fourth processing unit 114 may update the voice parameters of voice information extracted from the virtual-environment content using the second scores.

Alternatively, the fourth processing unit 114 may output voice information by modifying voice parameters of a sound source stored in a DB in accordance with the second scores. Here, the fourth processing unit 114 may select a sound source with similar voice parameter characteristics to the second score values to perform the above-described process.

The fourth processing unit 114 may extract a gray signal of pixels from a pixel matrix of the image information, determine a histogram of an image model, extract a scale and octave, and then synthesize the intensity of a sound using Csound.

Also, the fourth processing unit 114 may output voice information through an encoding and decoding process of stereophonic sound and reduce ambient noise and noise through a loudness correction algorithm.

The fourth processing unit 114 may transmit voice information to the HMD so that the voice information is played in synchronization with the image information.

The fifth processing unit 115 may be configured to determine the correlation index of the virtual-environment content by comparing the first scores with the second scores in accordance with the correspondence between the image parameters and the voice parameters.

The fifth processing unit 115 may apply weights in accordance with individual characteristics to determine the correlation index.

For example, the fifth processing unit 115 may be configured to determine the correlation index in accordance with the following equation.

### [Equation]

Correlation index=A1 (impact intensity/loudness)+A2 (color/timbre)+A3 (brightness/pitch)+A4 (contact/duration)

In the equation, A1, A2, A3, and A4 may be weights in accordance with individual characteristics. Bio information (brainwaves, heart rate variability (HRV), and the like) of users who experience virtual-environment content may be measured, and the weights may be set for each individual in accordance with the measured values. The weights A1, A2, A3, and A4 may be positive integers and may satisfy “A1+A2+A3+A4=10.”

A1 may be a weight obtained by measuring and exponentially evaluating each individual's degree of reaction to impact intensity and loudness. In other words, the weight A1 may be set larger with an increase in the reactivity to changes in impact intensity and loudness.

A2 may be a weight obtained by measuring and exponentially evaluating each individual's degree of reaction to color and timbre. In other words, the weight A2 may be set larger with an increase in the reactivity to changes in color and timbre.

A3 may be a weight obtained by measuring and exponentially evaluating each individual's degree of reaction to brightness and pitch. In other words, the weight A3 may be set larger with an increase in the reactivity to changes in brightness and pitch.

A4 may be a weight obtained by measuring and exponentially evaluating each individual's degree of reaction to a contact time and duration. In other words, the weight A4 may be set larger with an increase in the reactivity to changes in contact time and duration.

The fifth processing unit 115 may be configured to determine a possibility of motion sickness happening in accordance with the correlation index. With an increase in the difference between the correlation index and a preset value, the fifth processing unit 115 may be configured to determine that the possibility of motion sickness happening is lower.

Also, the fifth processing unit 115 may be configured to determine that the possibility of motion sickness happening is lower with a decrease in the difference between the correlation index and the preset value.

In other words, when scores of an image parameter and a voice parameter corresponding to each other have closer values, a correlation index includes a closer value to the sum of the weights. However, when there is a large difference between scores of an image parameter and a voice parameter, a correlation index includes a value that is larger or smaller than the sum of the weights. This means that, when quantitative indicators of an image parameter and a voice parameter corresponding thereto are more similar, a correlation index converges on the sum of the weights.

Therefore, the fifth processing unit 115 may be configured to determine that, when the correlation index converges on the sum of the weights, which is the preset value, a little mismatch is sensed between the image information and the voice information, and the possibility of motion sickness happening is low.

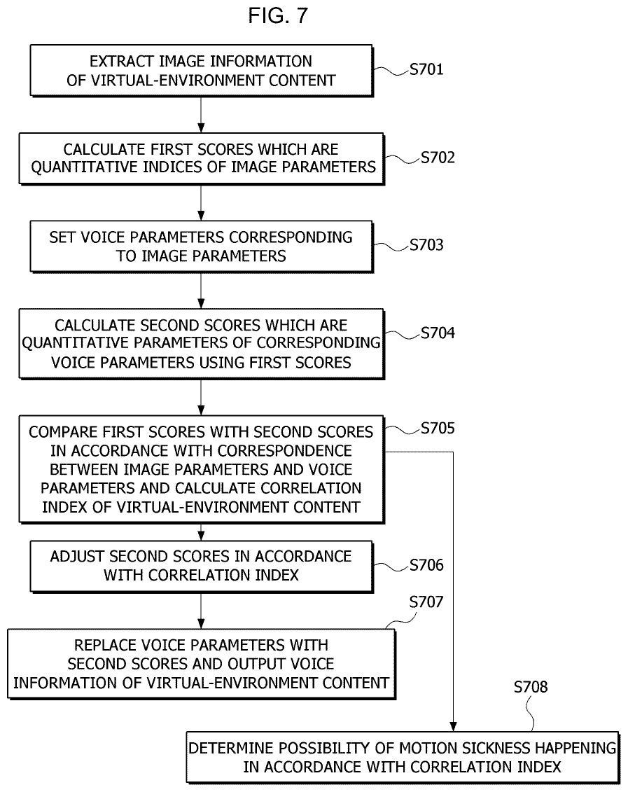

FIG. 7 is a flowchart of a method of managing virtual-environment content according to an exemplary embodiment of the present disclosure. Referring to FIG. 7, a processor extracts image information of virtual-environment content output through an HMD (S701).

Subsequently, the processor analyzes image parameters forming the image information and is configured to determine first scores which are quantitative indices of the image parameters (S702).

Subsequently, the processor is configured to set voice parameters corresponding to the image parameters (S703).

Subsequently, the processor is configured to determine second scores which are quantitative indices of the corresponding voice parameters using the first scores (S704).

Subsequently, the processor is configured to determine a correlation index of the virtual-environment content by comparing the first scores with the second scores in accordance with the correspondence between the image parameters and the voice parameters (S705).

Subsequently, the processor is configured to adjust the second scores in accordance with the correlation index (S706).

Subsequently, the processor replaces the voice parameters with the second scores and outputs voice information of the virtual-environment content (S707).

Furthermore, the processor is configured to determine a possibility of motion sickness happening in accordance with the correlation index (S708).

As used in an exemplary embodiment of the present disclosure, the term “unit” refers to software or a hardware component, such as an FPGA or an ASIC, and a unit is configured to perform certain roles. However, a unit is not limited to software or hardware. A unit may be configured to be in an addressable storage medium or operate one or more processors. Accordingly, as an exemplary embodiment of the present disclosure, a unit includes components, such as software components, object-oriented software components, class components, and task components, processes, functions, attributes, procedures, subroutines, segments of program code, drivers, firmware, microcode, circuits, data, DBs, data structures, tables, arrays, and variables. Functionality provided within components and units may be combined into a smaller number of components and units or subdivided into additional components and units. Furthermore, components and units may be implemented to operate one or more CPUs in a device or a secure multimedia card.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for managing virtual-environment content, the apparatus comprising:
at least one processor; and
a memory operatively connected to the at least one processor and configured to store at least one program executed by the at least one processor,
wherein the at least one processor includes:
a first processing unit configured to extract image information of the virtual-environment content output through a head-mounted display (HMD) operatively connected to the at least one processor;
a second processing unit configured to analyze image parameters forming the image information and determine first scores which are quantitative indices of the image parameters;
a third processing unit configured to set voice parameters corresponding to the image parameters and determine second scores which are quantitative indices of the corresponding voice parameters using the first scores; and
a fourth processing unit configured to output voice information of the virtual-environment content by replacing the voice parameters with the second scores.

2. The apparatus of claim 1, wherein the at least one processor further includes a fifth processing unit configured to determine a correlation index of the virtual-environment content by comparing the first score with the second score in accordance with correspondence between the image parameters and the voice parameters.

3. The apparatus of claim 2, wherein the third processing unit is further configured to adjust the second scores in accordance with the correlation index.

4. The apparatus of claim 2, wherein the fifth processing unit is further configured to determine the correlation index using weights in accordance with individual characteristics.

5. The apparatus of claim 2, wherein the fifth processing unit is further configured to determine a possibility of motion sickness happening in accordance with the correlation index.

6. The apparatus of claim 1, wherein the second processing unit is further configured to determine the first scores by analyzing the image parameters including impact intensity, color, brightness, and contact time.

7. The apparatus of claim 6, wherein the third processing unit is further configured to set loudness, timbre, pitch, and duration as the voice parameters corresponding to the impact intensity, the color, the brightness, and the contact time, respectively.

8. The apparatus of claim 7,
wherein the second processing unit is further configured to determine the first score of the impact intensity by quantitatively evaluating intensity of the image information, and
wherein the third processing unit is further configured to determine the second score of the loudness proportionate to the first score.

9. The apparatus of claim 7,
wherein the second processing unit is further configured to determine the first score of the color by quantitatively evaluating a color feeling of the image information, and
wherein the third processing unit is further configured to determine the second score of the timbre proportionate to the first score.

10. The apparatus of claim 7,
wherein the second processing unit is further configured to determine the first score of the brightness by quantitatively evaluating luminance of the image information, and
wherein the third processing unit is further configured to determine the second score of the pitch proportionate to the first score.

11. The apparatus of claim 7,
wherein the second processing unit is further configured to determine the first score of the contact time by quantitatively evaluating the contact time, and
wherein the third processing unit is further configured to determine the second score of the duration proportionate to the first score.

12. A method of managing virtual-environment content which is performed by a computing device including at least one processor and a memory operatively connected to the at least one processor and storing at least one program executed by the at least one processor, the method including:
extracting, by the at least one processor, image information of the virtual-environment content output through a head-mounted display (HMD) operatively connected to the at least one processor;
analyzing, by the at least one processor, image parameters forming the image information and determining first scores which are quantitative indices of the image parameters;
setting, by the at least one processor, voice parameters corresponding to the image parameters;
determining, by the at least one processor, second scores which are quantitative indices of the corresponding voice parameters using the first scores; and
replacing, by the at least one processor, the voice parameters with the second scores and outputting voice information of the virtual-environment content.

13. The method of claim 12, further including comparing, by the at least one processor, the first scores with the second scores in accordance with correspondence between the image parameters and the voice parameters and determining a correlation index of the virtual-environment content.

14. The method of claim 13, further including adjusting, by the at least one processor, the second scores in accordance with the correlation index.

15. The method of claim 13, further including determining, by the at least one processor, a possibility of motion sickness happening in accordance with the correlation index.

16. The method of claim 12,
wherein the determining of the first scores includes determining the first scores by analyzing the image parameters including impact intensity, color, brightness, and contact time, and
wherein the setting of the voice parameters includes setting loudness, timbre, pitch, and duration as the voice parameters corresponding to the impact intensity, the color, the brightness, and the contact time, respectively.

17. The method of claim 16, wherein the determining of the second scores includes determining the first score of the impact intensity by quantitatively evaluating intensity of the image information, and determining the second score of the loudness proportionate to the first score.

18. The method of claim 16, wherein the determining of the second scores includes determining the first score of the color by quantitatively evaluating a color feeling of the image information, and determining the second score of the timbre proportionate to the first score.

19. The method of claim 16, wherein the determining of the second scores includes determining the first score of the brightness by quantitatively evaluating luminance of the image information, and determining the second score of the pitch proportionate to the first score.

20. The method of claim 16, wherein the determining of the second scores includes determining the first score of the contact time by quantitatively evaluating the contact time, and determining the second score of the duration proportionate to the first score.
